(19) United States
(12) Patent Application Publication
(10) Pub. No.: US 2006/0212856 A1
(43) Pub. Date: Sep. 21, 2006

(54) System and method for tuning software engines

(76) Inventors: Steven John Simske, Fort Collins, CO (US); Xiaofan Lin, Palo Alto, CA (US); Sherif Yacoub, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/082,525

(22) Filed: Mar. 17, 2005

(51) Int. Cl. G06F 9/45

(52) U.S. Cl. 717/140

(57) ABSTRACT

A method, apparatus, and system are disclosed for tuning software engines. In one exemplary embodiment, a method for software execution includes activating copies of an un-tuned software engine capable of generating a solution domain to a given input; tuning a first un-tuned software engine to generate a first subset of the solution domain in response to the given input; and tuning a second un-tuned software engine to generate a second subset of the solution domain in response to the given input.

### BACKGROUND

Efficient deployment of a large number of redundant copies of software is important for network-based electronic services, hereinafter referred to as “e-services.” An example of an e-service provider is a server that remotely provides image or photo processing, such as editing, tagging, clustering, and associating. Such a server provides users with the capability of automated storage, retrieval, and metadata control of digital photos or scanned images stored in the server. Tasks such as workflow generation, data transmission, and socket connection are performed on the server remote from the user.

The image or photo processing server can include redundant copies of identical software configured to respond to requests of users or processes accessing the server for image or photo processing needs. Depending upon the request, the software performs various tasks related to the processing. In many servers, each copy of the software is configured to perform each of the possible tasks.

In addition to e-services, efficient deployment of redundant copies of software is also important for service-based applications in which access is obtained by voice, by handheld devices, or by other devices that have limited processing capability. A commercial scanning system is one example of such a service-based application. In some commercial scanning systems, the rate of page scanning on the automatic document feeder (ADF) is much faster than the rate at which a single optical character recognition (OCR) engine processes the documents being scanned. Thus, providing redundant engines configured to perform optical recognition is a constructive approach to enabling higher throughput performance.

Often, the redundant engines deployed in providing e-service applications and service-based applications are identically configured. In addition, each engine is configured to accept the same set of possible inputs so that any of the engines can be used to perform all of the requested tasks.

### BRIEF DESCRIPTION OF THE DRAWINGS

In the drawings, like reference numerals designate corresponding parts throughout the several views.

FIG. 1 is one exemplary embodiment showing a diagram of a deployment system in accordance with the present disclosure.

FIG. 2 is one exemplary embodiment of a diagram illustrating ground truth determination by deployment control logic of FIG. 1.

FIG. 3 is one exemplary embodiment of a flowchart illustrating architecture and functionality of the deployment control logic of FIG. 1.

### DETAILED DESCRIPTION

The present disclosure generally pertains to methods, apparatus, and systems for tuning software engines. In embodiments in accordance with the invention, software deployment systems, apparatus, and methods deploy copies of software engines and adjust the deployed engines to improve their performance, e.g., speed, throughput, and/or accuracy. In particular, a deployment system in accordance with one exemplary embodiment of the present disclosure generates, deploys, or activates multiple copies of a software engine, referred to hereinafter as an “un-tuned engine,” for deployment to a specific device or system. The un-tuned engine from which the copies are generated is configured to provide a set of solutions, referred to hereinafter as “the solution domain.” However, depending on the expected use of the specific device or system to which the copied engines are deployed, the deployment system “tunes” each deployed engine such that the tuned engine is configured to provide a reduced or improved set of solutions compared to the un-tuned engine. In particular, the deployed or tuned engine provides a specific subset of the overall solution domain of the un-tuned engine.

Embodiments in accordance with the present invention are utilized in a large variety of methods, systems, and apparatus. For example, OCR engines used in a scanning system are configured to receive binary data and translate the binary data into a textual or image representation of the binary data. The solution domain includes solutions related to the translation of the binary data. However, such a solution domain is divided into plural different subsets of solutions, such as a subset related to translation of text-only data, a subset related to translation of mixed data, and a subset related to translation of image-only data. Thus, the deployment system tunes each deployed engine such that the deployed or tuned engine is configured to process a particular one or ones of the task subsets.

As used herein, an “engine” refers to any software-based algorithm or service that provides a solution to a problem or a field of related problems. An engine is a program or group of programs that includes both systems software (i.e., operating systems and/or utility programs that manage computer resources at a low level) and applications software (i.e., end-user programs or programs that require operating systems and system utilities to run.). For example, an engine is configured for processing data related to optical character recognition (OCR), zoning analysis, speech analysis, photo analysis, compression/transmission/decompression, photo processing, medical imaging, and/or streaming graphical rendering engines. Embodiments in accordance with the present invention utilize a wide variety of engines, including large scale task-focused engines.

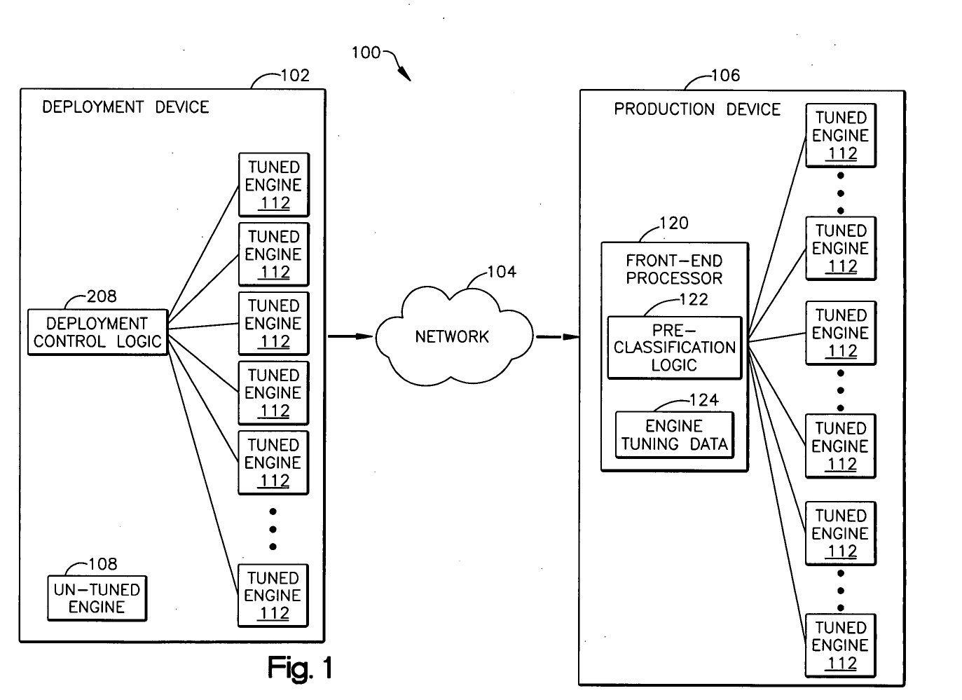

An exemplary deployment system 100 is shown in FIG. 1. The deployment system 100 comprises a deployment system or device 102 and a production system or device 106. A network 104 communicatively couples the deployment device 102 and the production device 106. The deployment device 102 comprises an un-tuned engine 108 and deployment control logic 208. The production device 106 comprises a front-end processor 120 and a plurality of engines 112, which will be described in more detail below. The front-end processor 120 comprises pre-classification logic 122 and engine tuning data 124.

The network 104 is not limited to any particular type of network or networks. The network 104, for example, includes a local area network (LAN), a wide area network (WAN), the internet, an extranet, or an intranet, to name a few examples. Further, the deployment and production devices are not limited to any particular embodiment. Such embodiments include, for example, computers (including personal computers), computer systems, mainframe computers, servers, distributed computing devices, and gateway computers, to name a few examples.

In operation, the deployment control logic 208 of the deployment device 102 replicates the un-tuned engine 108 to generate at least an “n” number of engines 112 to be stored in the production device 106 (wherein n is an integer >0). However, before transmitting the engines 112 to the production device 106, the deployment control logic 208 tunes the engines 112 such that each engine 112 is configured to provide a reduced or improved set of possible solutions as compared to the un-tuned engine 108 from which each tuned engine 112 is generated.

As used herein, tuning (and associated derivative words, such as tune, tunes, and tuned) includes, but is not limited to, adapting, adjusting, changing, and/or modifying. By way of example, if the un-tuned engine 108 generates a set of possible solutions, referred to as the “solution domain” of the un-tuned engine 108, then the deployment control logic 208, based on the expected use of the production device 106, tunes each engine 112. Each tuned engine generates only some of the solutions provided by the un-tuned engine 108 (such as a subset of the solution domain). In some embodiments, the solution domain of a tuned engine 112 is a subset of the solution domain of the un-tuned engine 108. Preferably, the tuned engine generates more accurate or more efficient solutions than the un-tuned engine 108.

Further, the pre-classification logic 122 is configured to receive requests to be processed by the tuned engines 112 on the production device 106 and to route such requests to one of the tuned engines based on the type of request received by the logic 122. The pre-classification logic 122 routes the requests to the appropriately configured tuned engine 112 in accordance with the engine tuning data 124 that comprises data indicative of each tuned engine and the type of subset that each tuned engine is configured to process.

The logic 122 routes each received request to a tuned engine that has been previously adapted or tuned to generate a solution to the specific type of received request. Thus, the tuned engine 112 that receives the request is capable of processing the received request and generating or calculating a solution to the received request. In some embodiments, the tuned engine 112 processing the request provides a reduced number of solutions and/or processes a reduced number or reduced type of received requests. Thus, the tuned engine processes the request in a much more efficient manner when compared to an un-tuned engine 108. In this regard, by having a smaller solution domain, it is likely that the tuned engine 112 will narrow the solution domain to the appropriate solution for the received request in less time, as compared to an un-tuned engine that has a larger solution domain from which to select the appropriate solution. Thus, by tuning the engines 112 such that the solution domain of each tuned engine 112 is a subset of the solution domain of the un-tuned engine 108, the overall efficiency of the production device 106 in responding to received requests is significantly increased.

In one embodiment, tuning is performed graphically or with a matrix to reduce or divide a given search space to a subset of smaller search spaces. For example, if an N×N search space exists, then this search space is reduced or partitioned to a plurality of subspaces, such as A×A, B×B, . . . , M×M, where the sum (A+B+ . . . +M)=N. In the limit, if there are no error cases between any of the classifications, then the order (N×N) system can be reduced to an order (N) system. As an example, if an original search space is a matrix of 20×20=400, then this search space is reduced or divided. For instance, the original search space is divided into two subsets or subspaces {X1 . . . X10} and {X11 . . . X20}. Here, each subset has a size 10×10 =100, which is one-half of the original search space.

Embodiments in accordance with the present invention can be implemented in a variety of embodiments. By way of example, assume that the un-tuned engine 108 is configured to perform optical character recognition (OCR) and convert image data of a document into strings of ASCII characters. Further assume that the un-tuned engine 108 is configured to process many different languages, such as English, Spanish, and French. To assist in character recognition, the un-tuned engine 108 comprises a table of English words, a table of Spanish words, and a table of French words. Further assume that the production device 106, on average, is expected to spend 50% of its processing time processing English documents, 30% of its processing time processing Spanish documents, and 20% of its processing time processing French documents.

In such an example, the deployment control logic 208 replicates the un-tuned engine 108 “n” number of times to generate “n” number of engines 112. The deployment control logic 208 tunes 50% of the engines 112 to process only English documents (e.g., the deployment control logic 208 deletes the tables of Spanish and French words from 50% of the engines 112). The deployment control logic 208 also tunes 30% of the engines 112 to process only Spanish documents (e.g., the deployment control logic 208 deletes the tables of English and French words from 30% of the engines 112). The deployment control logic 208 also tunes 20% of the engines 112 to process only French documents (e.g., the deployment control logic 208 deletes the tables of English and Spanish words from 20% of the engines 112).

In addition, the pre-classification logic 122 is configured to analyze the received requests and to determine which type of language is associated with the request. For example, if a request is requesting OCR for an English document, then the logic 122 transmits the request to one of the engines 112 tuned for processing English documents. Similarly, if a request is requesting OCR for a Spanish document, then the logic 122 transmits the request to one of the engines 112 tuned for processing Spanish documents. Likewise, if a request is requesting OCR for a French document, then the logic 122 transmits the request to one of the engines 112 tuned for processing French documents. Thus, each request is directed to an engine that has been tuned to process specific requests. In addition, the tuned engine 112 that receives the request processes the request more quickly and efficiently than the un-tuned engine 108. For example, an engine 112 tuned to process English documents (and not French or Spanish documents) searches only an English table when performing OCR for an English document. Notably, this engine 112 does not use processing resources searching the Spanish and French tables since such tables do not exist or the engine is programmed not to search them. If the request were processed by an exact replica of the un-tuned engine 108 on the other hand, then the Spanish and French tables could be inefficiently searched while performing OCR for an English document. Such searches add time to the OCR task and unnecessarily utilize processing resources. Similarly, the engines 112 tuned to process Spanish and French documents process requests in a more efficient manner, as compared to the un-tuned engine 108. Thus, by tuning the engines 112 as described above, the overall efficiency of the production device 106 is significantly increased.

Furthermore, the efficiency of the production device 106 is further increased by tuning the engines 112 based on the expected use of the production device 106. For example, processing resources of the production device are tuned and allocated according to anticipated or actual processing requests into the production device 106. In this regard, a higher percentage of the engines 112 are preferably tuned to tasks that consume a higher percentage of processing time of the production device. In the example described above, the percentages of engines 112 tuned to English, Spanish, and French correspond to (e.g., match) the expected processing times of the production device 106 in processing English, Spanish, and French documents. By doing so, the chances that requests will be delayed due to inefficient allocation of the tuned engines 112 are reduced.

In some embodiments, the production device 106 includes a system or computer running two or more copies of software (such as a licensed software engine) for specialize processing. Examples of production devices include, but are not limited to, telecommunication servers, document servers, web servers, large processing centers, and/or clusters of servers to provide large, real-time simultaneous processing of transactions (such as transactions in telecommunication, banking, document scanning & digitization & archiving, insurance, loans/financial, medical offices, etc.). Further, a production device 106 includes a system or computer that provides access to many distributed users. By way of further example, production devices include systems or computers configured for processing data related to optical character recognition (OCR), zoning analysis, speech analysis, photo analysis, compression/transmission/decompression, photo processing, medical imaging, mobile computing, and/or streaming graphical rendering engines.

In some embodiments, the deployment control logic 208 determines the number of licensed engines required to optimally run the production device 106. In this regard, the deployment control logic 208 determines the mean job time (MJT) of the production device 106 as implemented with the un-tuned engines and the percentage of expected input cases, e.g., text-only, mixed, and image-only documents. The deployment system 100 then determines the number of engines required to process that percentage of each input case. To determine the number of un-tuned engines for a scanning system, the following equation is used:
NL=(TPR)×(MJT). Equation A.0

Here, TPR is throughput performance requirement and MJT is mean job time. Thus, for the scanning device, if the MJT is 4 seconds/page and the system is expected to analyze up to 6 pages/second, then the number of licensed engines (NL) is equal to 6×4=24. However, if the engines are tuned in accordance with specified input cases, the overall performance is improved. Table 1 illustrates this concept:

TABLE 1

| | Percent | | |
|---|---|---|---|
| | Expected Input | Mean Job | (Percent) × |
| Input Cases | Cases | Time | (MJT) |
| Text-Only | 65.0% | 5.0 sec | 325.0 |
| Document | | | |
| Mixed | 25.0% | 6.0 sec | 150.0 |
| Document | | | |
| Image-Only | 10.0% | 1.0 sec | 10.0 |
| Document | | | |
| OVERALL | 100.0% | 4.85 sec | 485.0 |

In Table 1, the input cases include text-only documents, mixed documents, and image-only documents, and the expected percentage of input cases is 65%, 25%, and 10%, respectively. The expected number of text-only documents is greater than both mixed documents and image-only documents. Therefore, the expected number of engines tuned for text-only documents will be greater than the number of engines tuned for mixed documents or image-only documents.

The product of the percentage of the expected cases and the MJT for each input case provides the number of licenses that are used to optimize the throughput of the scanning system in considering the input cases. As shown, 325 licensed engines are tuned or devoted for text-only documents; 150 licensed engines are tuned or devoted for mixed documents; and 10 licensed engines are tuned or devoted for image-only documents. A scanning system having engines tuned with this configuration could simultaneously process, for example, 325 text-only pages of a document, 150 mixed pages of a document, and 10 pages of an image-only document. This simultaneous processing improves performance because the automatic document feeder (ADF) of the scanning device operates at a higher rate of speed than the OCR engines translating the data. Thus, as each text-only, mixed, or image document is scanned, the scanning device transmits each page to one of the plurality of engines tuned for the particular type of document.

With reference to Table 1, the overall decrease in MJT is described mathematically as follows:
OVERALL MJT=Σ(% Input Case)(MJT). Equation A.1

Here, the OVERALL MJT of the scanning system is equal to the summation of the product of the percentage of each input case and the MJT of each input case. Thus, for the OCR example, the OVERALL MJT for the scanning device is calculated as follows:
OVERALL MJT=(0.65×5.0)+(0.25×6.0)+(0.1×1.0)=4.85 sec. Equation A.2

Notably, the largest MJT, 6.0, for the mixed document input case is greater than the overall MJT, 4.85, which illustrates the enhanced overall performance of the engines 112 of the scanning system. Further, the MJTs of the un-trained system represent the MJT using un-tuned licensed engines.

Tuning engines to be task-specific according to the input cases lowers the overall MJT in the receiving production device 106 from 6.0 seconds to 4.85 seconds. Practically, a document is scanned in, and regardless of the type of document (i.e., text, mixed, or image) the tuned scanning system completes the job in 4.85 seconds on average. The improved performance are measured as follows:
Improved Performance=((MJT Mixed−MJT Overall)/MJTOverall)×100 Equation A.3
Improved Performance=((6.0−4.85)/6.0)×100=19.2% Equation A.4

Thus, there is an overall improvement of 19.2% when each engine is tuned to a particular input case.

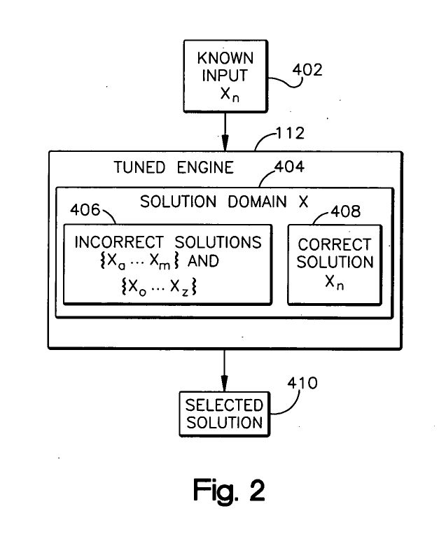

With reference to FIG. 2, the deployment control logic 208 (FIG. 1) begins the tuning process by establishing “ground truth.” Ground truth refers to a one-hundred percent (100%) accurate depiction of the performance of the engines. In essence, determining ground truth is accomplished by providing a known parameter to an engine and recording the solution provided by the engine to determine a relative probability that the solution provided is an incorrect solution. Thus, ground truth is represented in varying forms including a confusion matrix, a lookup table, or the like.

Generally, in establishing ground truth, the deployment control logic 208 determines a set of incorrect solutions represented by box 406 for a given correct solution Xₙ out of“z” possible solutions. Further, for the set of incorrect solutions 406, the deployment control logic 208 calculates a probability that the engine will provide each incorrect solution instead of the correct solution.

In order to determine ground truth for an engine 112 (FIG. 1), the deployment control logic 208 (FIG. 1) provides a known input Xₙ as indicated in block 402 to the tuned engine 112. For example, the deployment control logic 208 provides the character “C.” Therefore, the correct solution of the engine should necessarily be the character “C.” The correct solution Xₙ belongs to an entire solution set X represented as follows:
X={Xₐ. . . X_{z}}. Equation B.1

The deployment control logic 208 establishes ground truth by recording the behavior of the engine when the engine provides incorrect solutions, for example, within incorrect solution sets {Xₐ . . . Xₘ} and/or {Xₒ . . . X_{z}} indicated by block 406 within the entire set of solutions X indicated by block 408. Upon determination of the incorrect solutions {Xₐ . . . Xₘ} within the entire set X that the engine produces as the selected solution 410 for the known input Xₙ, the deployment control logic 208 further associates with each incorrect solution in the incorrect solution set a probability that the engine will produce the associated incorrect solutions for the correct solution Xₙ.

For example, given an entire solution set X as represented in equation B.1, if {Xₐ . . . Xₘ} have nonzero probability of being selected in place of Xₙ (i.e., the known input Xₙ, but {Xₒ . . . X_{z}} have zero probability of being selected in place of Xₙ), then rather than storing the zero probabilities for set {Xₒ . . . X_{z}}, it is more efficient to store the X-terms included in the set {Xₒ . . . X_{z}} exhibiting nonzero probabilities. The data indicative of the ground truth of the engine 112 are stored as a confusion matrix or a lookup table in the deployment device 102. An exemplary error probability is generated corresponding to the ground truth.

In light of the foregoing, the deployment control logic 208 properly tunes and deploys the same licensed copies of an engine with different input/output specifications. However, in deployment, the deployment control logic 208 reduces many of the incorrect terms (i.e., {Xₒ . . . X_{z}}) from consideration altogether. Such elimination of entire sets of incorrect terms improves the performance and accuracy of the production device 106 by reducing the set of requisite decisions that an engine makes in calculating and producing an output.

As noted, a wide variety of embodiments are utilized in accordance with the present invention. For example, in an OCR engine, a solution is a single character. As another example, if a zoning analysis engine is used, the solution is a single segmented and/or classified region. Another example is an engine for speech analysis wherein the solution is a single word or phoneme (i.e., sound or utterance). A final example is a photo processing engine wherein the solution is a single identified photograph.

In optimizing deployment of the engines 112, the deployment control logic 208 determines the number of licensed engines required, a deployment case, and an input case. Each of the enumerated determinations and the methodology employed by the deployment control logic 308 are further discussed.

The number of licensed engines suitable or optimal for a particular receiving device 106 is determined by the throughput performance requirement (TPR) and the mean job time (MJT) of the receiving device 106. Thus, under simple conditions, the number of licensed engines suitable for the production device 106 is represented by the following formula:
N_{L}=(TPR)×(MJT). Equation C.1

Here, N_{L} represents the number of licensed engines 112, “TPR” represents throughput performance requirement in jobs per second job/sec), and “MJT” represents the mean job time in seconds/job (sec/job).

For example, an OCR system supporting commercial scanning has an MJT of 4.0 seconds/page. Note that MJT is the average time that it takes an OCR-based receiving device 106 to perform optical character recognition of a particular page. Furthermore, the scanner of the receiving device 106 is capable of scanning 6 pages/second. Thus, in accordance with equation C.1, the number of licensed engines that fulfill the specifications of the scanner is determined by the formula:
N_{L}=6 pages/second×4 seconds/page Equation C.2
N_{L}=24. Equation C.3

Thus, equation C.1 indicates that twenty-four licensed engines would effectively meet the receiving device 106 TPR and MJT specifications.

Consider another example wherein a telephony system employing automated speech recognition (ASR) has a MJT of three (3) seconds per job and a TPR of 200 jobs per second. Thus, in accordance with equation C.1, the number of licensed engines that fulfill the specification of the telephony system are determined by the following formula:
NL=200 tasks/second×3 seconds/task Equation C.4
NL=600. Equation C.5

Thus, equation C.1 indicates that six hundred licensed engines would effectively meet the receiving device 106 TPR and MJT specifications.

In the discussed examples, each relevant “input case” is useful in determining the MJT. Note that a set of “input cases” comprises each type of input case corresponding to the type of receiving device 106 being considered. Further, the input cases associated with a particular receiving device affects the number of licenses, such as 24 licensed engines in the example of the OCR system and 600 licensed engines in the example of the telephony system.

Consider the following example of a telephony system characterized by the following table:

TABLE 2

| | Percent | | |
|---|---|---|---|
| | Expected | Mean Job | (Percent) × |
| Input Cases | Input Cases | Time | (MJT) |
| High | 40.0% | 1.1 sec | .44 |
| Frequency | | | |
| Voice | | | |
| Medium | 40.0% | 1.0 sec | .4 |
| Frequency | | | |
| Voice | | | |
| Low | 10.0% | 2.3 sec | .23 |
| Frequency | | | |
| Voice | | | |
| Unknown | 10% | 2.5 | .25 |
| OVERALL | 100% | 2.5 max | 1.32 |

Table 2 illustrates that the deployment control logic 208 determines MJT by considering the various input cases (i.e., high frequency voice, medium frequency voice, low frequency voice, and unknown) of a telephony network receiving device 106. The deployment control logic 208 determines the overall job time in accordance with the following equation:
OVERALL MJT=Σ((% Input Cases)(MJT)). Equation D.5

Here, the OVERALL MJT of the receiving device 106 is equal to the summation of the product of the percentage of each input case in relation to the overall device 106 and the MJT of each input case. Thus, the OVERALL MJT for the receiving device 106 is calculated as follows:
OVERALL MJT=(0.4×1.1)+
(0.4×1.0)+
(0.1×2.3)+
(0.1×2.5)=1.32 seconds. Equation C.6

Therefore, after taking into account the input cases (i.e., high frequency voice, medium frequency voice, low frequency voice, and unknown), the mean job time is now 1.32, which is less than the largest mean job times, 2.3 and 2.5, for the low frequency voice and the unknown input case, respectively. Note that the entire solution domain (i.e., all the expected input cases) and the subsets include the enumerated frequencies. The MJT of the untrained input case represents the MJT for un-tuned licensed engines. However, tuning four engines (one for each respective input description) decreases the MJT of the receiving device 106. The increased performance is measured as follows:
Improved Performance=((MJT Mixed−MJT Overall)/MJT Overall)×100 Equation D.7
Improved Performance=((2.5−1.32)/6.0)×100=47.2% Equation D.8

Thus, there is an overall improvement of 47.2% over the un-trained/un-tuned case when the engines are tuned to each particular input case.

The input case need not be solely based on the expected types of inputs. For example, in a photo-server utilizing e-service receiving device 106, the overall bandwidth capabilities dictate TPR. In this case, the number of engines depends on the transmission requirements for each job. For example, TPR is much lower for certain types of tasks than for others simply because the bandwidth for these tasks will be more quickly filled. Preferably, such input case descriptions account for both MJT and TPR in their estimates for NL, as shown in Table 3.

TABLE 3

| | Percent | Mean | | |
|---|---|---|---|---|
| | Expected Input | Job | | |
| Input Cases | Cases | Time | TPR | NL = MJT × TPR × % |
| Upload | 30.0% | 45 sec | 2 | 27 |
| Download | 30.0% | 20 sec | 4 | 24 |
| Cluster | 10.0% | 1 sec | 20 | 2 |
| Metadata Tag | 30% | 2 sec | 20 | 12 |
| OVERALL | 100% | 20.2 | 9.8 | 65 |

Table 3 illustrates the use of the input case descriptions to predict MJT for a photo-server based e-service. The overall estimate of NL is 65, which is lower than taking overall (MJT×TPR) that equals 197.96 or by taking the NL required for the highest input case (MJT×TPR) equal 90 for upload input cases.

The deployment control logic 208 then determines the deployment case, which refers to how the licensed engine is actually tuned. The deployment control logic 208 assigns a number of licensed engines, N_{L}, for each input case, Hₙ, where the number of licenses for an entire receiving device 106 are determined by the following formula:
Σ(N_{H})=N_{L}. Equation E.1

Here, N_{H} represents the addition of each number of licensed engines determined previously for a receiving device 106. For each input case, the deployment control logic 208 sums the number of licensed engines to obtain a total number of licensed engines for all of the determined inputs.

Consider the following table:

TABLE 4

| | Percent | | | NL Relative |
|---|---|---|---|---|
| | Expected | | PEC × (MJT) = | to 100 |
| | Input Cases | Mean Job | Relative | Engines |
| Input Cases | (PEC) | Time | NL | Overall |
| Text-Only | 65.0% | 5.0 sec | 325.0 | 67.0 |
| Document | | | | |
| Mixed | 25.0% | 6.0 sec | 150.0 | 30.9 |
| Document | | | | |
| Image-Only | 10.0% | 1.0 sec | 10.0 | 2.1 |
| Document | | | | |
| OVERALL | 100% | 4.85 sec | 485.0 | 100 |

Table 4 represents the deployment case for the commercial scanning example in FIG. 1. As described in Table 1, analysis by the deployment control logic 208 to determine the number N_{L} of engines needed for performing the tasks described (i.e., scanning text-only document, mixed document, and image-only document) for a receiving device 106 resulted in the determination that 325 un-tuned engines were needed to process the text-only input cases, 150 un-tuned engines were needed to process the mixed input cases, and 10 un-tuned engines were needed to process the image-only documents. The deployment control logic 208 determines the N_{L} in accordance with the relative percentages of the each type of input case and the MJT of each input case.

In order to tune the engines to improve performance of the receiving device 106 in production, the deployment control logic 208 calculates the number of licenses that the receiving device 106 needs in order to perform the same volume of throughput employing tunable engines 112.

The deployment control logic 208 chooses the number of licensed tunable engines relative to 100 that reflect by calculating the number, N_{L}, out of 100 reflects the relative N_{L} of the input case. In this regard, the deployment control logic 208 generally determines what percentage of the overall N_{L} the particular input case in question comprises. For example, three-hundred and twenty-five (325) licensed un-tunable engines of four-hundred and eighty-five (485) licensed un-tunable engines are dedicated to the text-only input case. The following illustrates the formula for calculating the number of tunable engines for a particular input case:
N_{LTic}=N_{LUic}/N_{LU}×100. Equation E.2

Here, N_{LTic} represents the number of licensed tunable engines dedicated to a particular task, N_{LU} represents the total number of licensed untunable engines on the receiving device 106, and N_{Luic} represents the number of licensed untunable engines dedicated to a particular task.

Thus, with reference to Table 4, in order to determine the deployment case of each input case, the deployment control logic 208 calculates the following values for the deployment case:
N_{LTtext-only}=325/485×100=67; Equation E.3
N_{LTmixed}=150/485×100=30.9; and Equation E.4
N_{Ltimage-only}=10/485×100=2.1. Equation E.5

These equations represent the number of licensed tunable engines N_{Lttext-only} that are dedicated to the text-only input case, the number of licensed tunable engines N_{LTmixed} that are dedicated to the mixed input case, and the number of licensed tunable engines N_{LTimage-only} that are dedicated to the image-only input case.

The foregoing examples corresponding to Tables 1-4 illustrate exemplary embodiments of the deployment control logic 208. In this regard, the analysis and determinations throughout make multiple assumptions. Some of these assumptions are more fully described below.

First, the deployment control logic 208 operates on the assumption that the number of licenses of a particular tuned engine is determined based on reliable estimates for TPR and MJT. If the TPR and MJT are erroneous, then the number of licenses calculated by the control logic 208 can also be erroneous.

Further, the foregoing analyses by the deployment control logic 208 assume that the number of distinct input case sets, hereinafter referred to as “H,” to which to tune the engine is determinable and the degree of overlap between the H sets is minimal, i.e., independent. In this regard, however, a further assumption is that the performance of each engine for clustered solution subsets is irrelevant based upon the assumption that the sets are independent.

Finally, the analysis is performed by the deployment control logic 208 on the assumption that the performance of the tunable engines when the engines are all tuned to the sum of all input case sets and all engines are tuned the same is poorer than the performance when the clustered sets are used, and all Nₕ<N_{L} since each Nₕ>0.

In some situations, the assumptions are not valid and should be tested. Further, if the assumptions are appreciably valid and the default situation in which N_{L} engines are each tuned to the overall input set is not deployed, then customized deployment is used.

For instance, in the commercial scanning example provided herein, the fact that the document type is ascertainable prior to zoning or OCR allows the input cases as presented in Table 1 to be assigned to the scanned documents. Thus, the assumption (i.e., that the distinct input case sets for which to tune the engine are determinable) is valid and holds.

Further, the ASR telephony system provided as another example herein uses a fast Fourier transform (FFT) in order to detect the frequency of the voice. Thus the ASR system classifies the voice as high frequency, medium frequency, and/or low frequency. Therefore, since the input case sets are ascertainable, the assumption (i.e., that the number of distinct input case sets for which to tune the engine is determinable) is valid and holds.

An automated human-machine conversation is another example of a system with determinable input case set. In such system, the vocabulary input cases are inherently different at different stages in the process. At a first stage for example, the machine requests the user to select an option by speaking a numerical value. Therefore, the input case set comprises the following:
H={1, 2, 3, 4, 5, 6},
where H represents the input case set. In such an input case, the engine are tuned so other inputs are not allowed or processed. Further, there exists other incorrect inputs (e.g., too for two, won for one, and fore for four); however, such incorrect inputs are automatically eliminated. Elimination of these inputs occurs because the engine 112 is tuned to only accept and process numerical inputs.

Once the deployment control logic 208 determines the relevant subclasses of deployment cases (i.e., tunes the engine), the control logic 208 determines the relevant subclasses of input cases. Note that subclasses of deployment classes overlap and create a hybrid case comprising each of the overlapping subspace combinations, hereinafter referred to as a “clustered input case,” which is identified as a “P” set.

In order to optimize engine set performance, the deployment logic 208 determines whether it is optimal to combine none, some, or all of the subsets that overlap. The process of determining whether it is optimal to combine is described hereinafter. To determine whether it is optimal to combine subsets, the deployment control logic 208 performs a component analysis by creating a matrix of correlation to determine interdependencies. For example, returning back to the telephony system described herein, the vocabulary at each stage exists as follows:

1. Enter a first and last name;

2. Enter identifying social security number;

3. Spell password; and

4. Enter a number from,1 to 10.

With respect to the input cases 1 and 3, each input is a random combination of phonemes and, as such, is not capable of being tuned to specific input case sets. However, the input case sets for 2 and 4 are ascertainable.

The deployment control logic 208 then determines a deployment case, which is a case defining how the engine is actually tuned. Thus, ASR engine 112 is deployed in any number of ways that is suitable to effectuate automatic speech recognition.

Optionally, each licensed ASR engine is separately deployed in a manner consistent with the task of each ASR engine. For example, the deployment control logic 208 is deployed as a phoneme list. This phoneme list is then compared to the phoneme representations of a name database that is to make up the ASR system, hereinafter referred to “1.” The control logic 208 deploys the engine as a general word identification process in which the voice data is first broken into words and then compared to the name database.

In another option, the deployment control logic 208 deploys the ASR engine with a {0 . . . ∞} all number vocabulary that is sufficient for processing the social security input, the password if needed, and the number from 1-10. Together with this engine, the deployment control logic 208 also deploys an ASR engine with a {0. . . 9, A . . . Z} vocabulary in order to process the first and last name and the password or a {0 . . . 9} vocabulary, hereinafter referred to as “2.”

In yet another option, the deployment control logic 208 deploys the ASR engine with a {0 . . . 9, A . . . Z } vocabulary that is sufficient for processing the name, social security number, and a portion of the password. This ASR engine are separately deployed or together with a {0 . . . 9} vocabulary that is sufficient for processing the social security input, the password if needed, and the number from 1-10, hereinafter referred to as “3.”

In another option, the deployment control logic 208 deploys the ASR engine with a {0 . . . 9} vocabulary that is sufficient for processing the social security number and a portion of the password. This ASR engine is separately deployed or together with a {0 . . . 9, A . . . Z} vocabulary that is sufficient for processing the name, social security number, and a portion of the password or {0 . . . ∞} that is sufficient for processing the social security number, the number portion of the password, and/or the number 1-10, hereinafter referred to as “4.”

It is possible to simultaneously deploy, for example, {1} and {3} without unnecessary introduction of error. For example, if in {3} the solution for the combined vocabulary {0 . . . ∞, A . . . Z} should be “60,” which is an invalid entry for Opt3, with vocabulary {0 . . . 9, A . . . Z}, “60” is mapped to its best replacement.

Generally, the number of vocabulary combinations possible is high. The following set of deployment cases illustrates some examples:
Case 1={1, 2, 3, 4} together;
Case 2={2}, {2}, {3} and {4} separately;
Case 3={1,2}, {3}, {4}; and
Case 4={1,2}, {3,4}
Case 5={1,3}, {2}, {4}
Case 6={1,3}, {2,4}
Case 7={1,4}, {2}, {3}
Case 8={1,4}, {2, 3}
Case 9={1, 2, 3}, {4}
Case 10={1, 2, 4}, {3}
Case 11={1, 3, 4}, {2}
Case 12={1}, {2}, {3,4}
Case 13={1}, {3}, {2,4}
Case 14={1}, {4}, {2,3}
Case 15={1}, {2, 3, 4}

Note that for a particular licensed engine deployment, the number of possible deployment cases rapidly increases as the number of licensed engines increase. In this regard, the following table illustrates this assertion:

TABLE 5

| | N | | | | |
|---|---|---|---|---|---|
| | 1 | 2 | 3 | 4 | 5 |
| N_{DCP} | 1 | 2 | 5 | 15 | 52 |

Although fifteen deployment cases are possible given the four options “1”-“4” described herein, the deployment control logic 208 then winnows the number down by logically determining those cases that are reasonable in light of the solution domain of the receiving device 106. For example, each case 5-11 indicates deploying “1” with additional options, i.e., {1,3},{1,4}, {1, 2, 3}. As described herein, 2, 3, and 4 each describes deployment cases wherein the case is deployed either separately or with 3/4, 2/4, or 2/3, respectively. Therefore, cases 5-11 are eliminated in that {3}, {4}, and {2} would not be deployed in these cases either separately or with the prescribed combinations.

Thus, the deployment control logic 208 determines that the following deployment cases are reasonable cases for testing:
Case 1={1, 2, 3, 4} together;
Case 2={1}, {2}, {3} and {4} separately;
Case 12={1}, {2}, {3,4}
Case 13={1}, {3}, {2,4}
Case 14={1}, {4}, {2,3}
Case 15={1},{2, 3, 4}

The deployment control logic 208 then tests each of the six cases (i.e., case 1, 2, 12, 13, 14, and 15) for performance and accuracy of the deployment of engines by first assigning each engine a default number of licensed engines, N_{L}, based on their MJT and TPR. Table 6 illustrates estimates that occur for each of these cases:

TABLE 6

| Input | Mean Job | |
|---|---|---|
| Cases | Time | TPR |
| {1} | 3.0 sec | Q |
| {2} | 4.0 sec | Q |
| {3} | 2.0 sec | Q |
| {4} | 1.0 sec | Q |

Thus, if N_{L}=80, then 24 will be deployed for {1}, 32 for {2}, 16 for {3}, and 8 for {4}. Assuming the combinations of the engines will be largely consistent to these relative MJTs, then any combination Nₕ is determined by summing those of its parts, e.g., Nₕ{2,3}=Nₕ{2}+Nₕ{3}=48.

Therefore, the following results are determined for the tested cases:

Case 1. {1, 2, 3, 4} N₁₂₃₄=80

Case 2. {1} N1=24; {2} N2=32; {3} N3=16; {4} N4=8

Case 12. {1} N1=24; {2} N2=32; {3,4} N34=24

Case 13. {1} N1=24; {3} N3=16; {2,4} N24=40

Case 14. {1} N1=24; {4} N4=8; {2,3} N23=48

Case 15. {1} N1=24; {2, 3, 4} N234=56

After determining the deployment cases, the deployment control logic 208 deploys the cases for testing. The following table illustrates exemplary metrics obtained in testing:

TABLE 7

| | | Word Error |
|---|---|---|
| CASE | TPR Normalized | Rate (WER) |
| Case 1 | 1000 Normalized Time Units | 2.3% |
| Case 2 | 980 Normalized Time Units | .85% |
| Case 12 | 890 Normalized Time Units | 1.3% |
| Case 13 | 850 Normalized Time Units | .95% |
| Case 14 | 780 Normalized Time Units | 1.10% |
| Case 15 | 960 Normalized Time Units | 1.55% |

From Table 7, case 14 performs a task in the shortest period of time, i.e., 780 normalized time units. However, case 2 exhibits the best overall word error rate.

In another embodiment, the deployment control logic 208 optimizes deployment of licensed engines using a “Method of Largest Gradient,” (MLG).

Following optimization, the deployment logic 208 then determines a cost function representative of the simulations tested, e.g., the simulations for case 1, 2, 12-15. Note that “cost function” refers to a function of input variables and an output quantity. The value of the cost function is the cost of making that output given those input variables.

In the described example of the telephony system, a different case would be selected to optimize performance than to optimize accuracy. With reference to Table 7, case 2 would be selected to minimize error in accuracy, but case 14 would be selected to maximize throughput performance. Further, cases 1, 12, and 15 provide poorer throughput and word error rate than other cases, e.g., case 13. Thus, the deployment control logic 208 eliminates cases 1, 12, and 15 to obtain the following relevant cases:

Case 2: Minimizes WER (TPR=980), WER=0.85%);

Case 13: Minimizes some cost function in TPR and WER (TPR=850, WER=0.95; and

Case 14: Minimizes TP (TP=780, WER=1.10%)

Thus, the deployment control logic 208 determines the cost function(s) associated with the telephony system. If only throughput performance (TP) and the word error rate (WER) are considered in the cost function, then the cost function, “C,” is represented as:
C=f(TP,WER). Equation F.1

If the function is simply first order, the cost function is represented as:
C=k1(TP)+k2(TER) Equation F.2

The nature of Equation F.1 will depend on the application, but in many cases the simple Equation F.2 will suffice if there is a direct, consistent ratio of cost between performance and error. For example, how valuable is it that no calls are missed is quantitatively indicated by the constant k1. How much it costs when the ASR engine misinterprets the caller's verbiage, which affects k2 and is estimated from the cost of having human operators to respond to errors.

In light of the foregoing, if k2=3k1 and the costs involved in processing every 1% of errors are three times as expensive as every one normalized FP unit with respect to lost business, customer irritation, effects on system performance, etc., then the cost function is represented as the following:
C=(TP/1000)+3(WER/1%) Equation F.3

Therefore, the deployment control logic 208 determines the following:
Case 2: C=(980/1000)+3(0.85/1.00)=0.98+2.55=3.53;
Case 13: C=(850/1000)+3(0.95/1.00)=0.85+2.85=3.7; and
Case 14: C=(780/1000)+3(1.10/1.00)=0.78+3.30=4.08.

Thus, the deployment logic 208 would select case 2. Note that other cost functions known in the art or developed in the future could be used in place of the cost function described hereinabove. However, the cost function described is simple and is appropriate for linear relationships between k1 and k2. Further, in some embodiments, such linear equations are all that is required to provide good cost functions, especially if dynamic updating of these k-values is engendered.

After the deployment control logic 208 has determined optimal deployment through the cost function described hereinabove, then the deployment control logic 208 collects data to measure and estimate performance improvement. The control logic 208 employs the data, for example, in providing reports indicating percent improvements in throughput and accuracy compared to competitors' products as a differentiator. In addition, the licensing costs are reduced by requiring fewer licenses to meet throughput objectives. Further, the deployment logic 208 improves accuracy further by tuning engines to exhaust extra processing time freed-up by optimized deployment.

Alternatively, the deployment control logic 208 is implemented with dynamic update capabilities such that the control logic 208 monitors the important parameters in the cost function, e.g., throughput and word error rate. In this regard, the deployment control logic 208 continually updates the deployment and/or cost function based on system error, quality, etc., feedback. Recorded values indicative of time spent on particular tasks and the make-up of the input cases, for example, are used to update dynamically the values of the deployment and dynamically update the system parameters.

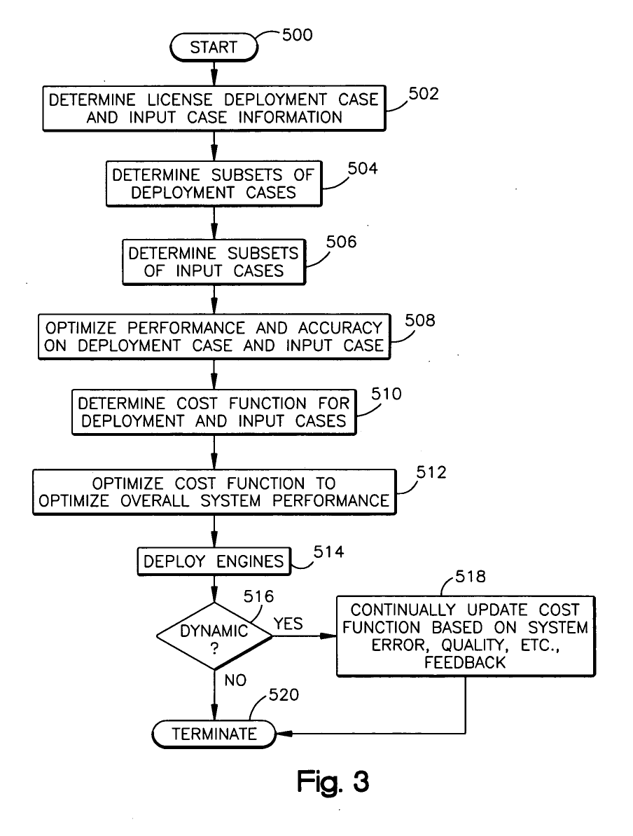

An exemplary architecture and functionality of deployment control logic 208 is described with reference to FIG. 3. The flow diagram starts at block 500. The deployment logic 208 determines the number of licensed engines 112 needed at a particular receiving device 106 (FIG. 1), as indicated in step 502. The logic 208 then determines the subsets of the deployment case to apply to the engines of the receiving device, as indicated in step 504 and the input cases, as indicated in step 506. As described herein, the input cases describe the input types that the engine receives during production, e.g., document types if it is an OCR engine, bandwidths if it is an ASR engine, etc.

The deployment control logic 208 then optimizes performance and accuracy based on deployment case and input case, as indicated in step 508. The deployment control logic 208 then determines a cost function for the deployment and input cases, as indicated in step 510, and optimizes the cost function to optimize overall system performance, as indicated in step 512.

The deployment logic 208 deploys the engines, as indicated in step 514. Per step 516, a query is made whether dynamic updates occur. If dynamic update of any of the important parameters in the cost function is to be incorporated in the optimized deployment system as determined in step 516, then the deployment control logic continually updates the deployment and/or cost function based on system error, quality, and/or feedback, as indicated in step 518. If no dynamic updates occur, then the final deployment recommendation is made and the engines are deployed. The flow diagram terminates at block 520.

Embodiments in accordance with the present invention are implemented in a variety of networks, and such networks are not limited to computing networks (such as the network discussed in connection with FIGS. 1-3). For example, other types of communication networks are also applicable. Such networks include, but are not limited to, the internet, intranets, extranets, a digital telephony network, a digital television network, or a digital cable network, various wireless and/or satellite networks, to name a few examples.

FIG. 3 provides a flow diagram in accordance with embodiments of the present invention. The diagram is provided as an example and should not be construed to limit other embodiments within the scope of the invention. For example, the blocks should not be construed as steps that must proceed in a particular order. Additional blocks/steps can be added, some blocks/steps removed, or the order of the blocks/steps altered and still be within the scope of the invention

In the various embodiments in accordance with the present invention, embodiments are implemented as a method, system, and/or apparatus. As one example, the embodiment is implemented as one or more computer software programs to implement the method of FIG. 3. The software is implemented as one or more modules (also referred to as code subroutines, or “objects” in object-oriented programming). The location of the software (whether on the client computer or elsewhere) will differ for the various alternative embodiments. The software programming code, for example, is accessed by the microprocessor of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory, and accessed by the microprocessor using the bus. The techniques and methods for embodying software programming code in memory, on physical media, and/or distributing software code via networks are well known and will not be further discussed herein. Further, various calculations or determinations (such as those discussed in connection with FIGS. 1-3) are displayed (for example on a display) for viewing by a user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method for software execution, comprising:
activating copies of an un-tuned software engine capable of generating a solution domain to a given input;
tuning a first un-tuned software engine to generate a first subset of the solution domain in response to the given input; and
tuning a second un-tuned software engine to generate a second subset of the solution domain in response to the given input.

2) The method of claim 1 wherein the first and second tuned software engines execute the given input with less processing resources than the un-tuned software engine executing the given input.

3) The method of claim 1 wherein the first tuned software engine is tuned to perform a first task-specific processing function, and the second tuned software engine is tuned to perform a second task-specific processing function different than the first task-specific processing function.

4) The method of claim 1 further comprising:
transmitting, via a network, the first and second tuned software engines to a production device;
receiving, at the production device, a processing request;
routing the processing request to one of the first or second tuned software engines that is tuned to more efficiently execute the processing request.

5) A method for software execution, comprising:
deploying plural copies of a software engine, the software engine processing a given task to produce a solution domain;
tuning the plural copies such that each tuned copy processes a different portion of the given task to produce a subset of the solution domain; and
transmitting, via a network, the tuned plural copies to a production device.

6) The method of claim 5 further comprising:
receiving, at the production device, a request to process a first portion of the given task;
matching the first portion of the given task with one tuned copy that has been specifically tuned to process the first portion.

7) The method of claim 5 further comprising determining a number of copies of the software engine to optimally process the given task at the production device.

8) The method of claim 5 further comprising:
calculating a mean job time (MJT) of the software engine to process the given task;
calculating a MJT of the tuned plural copies to process the given task.

9) The method of claim 5 wherein a first tuned copy is tuned to perform optical character recognition (OCR) on text-only documents, a second tuned copy is tuned to perform OCR on image-only documents, and a third altered copy is tuned to perform OCR on both text and image documents.

10) The method of claim 5 further comprising:
scanning a document;
sending, based on content in the scanned document, the scanned document to one of the tuned plural copies that was tuned to process the content in the scanned document.

11) The method of claim 5 wherein tuning the plural copies further comprises tuning each of the plural copies to perform task-specific processing of a different portion of the given task.

12) The method of claim 5 further comprising:
determining a ground truth for the production device by providing a known parameter to the software engine so the software engine can generate a solution;
determining a relative probability that the solution is incorrect.

13) A computer-readable medium having computer-readable program code embodied therein for causing a computer system to:
activate multiple copies of a software engine that generates a solution domain to a given input;
tune the multiple copies such that each of the tuned copies generates a different subset of the solution domain to the given input; and
transmit the tuned copies to a production device to optimize performance of the production device in processing the given input.

14) The computer-readable medium of claim 13 wherein the tuned copies are transmitted via a network to the production device.

15) The computer-readable medium of claim 13 wherein the solution domain is an N×N matrix, and the different subsets of the solution domain include plural matrixes of A×A, B×B, . . . M×M,wherein the sum (A+B+. . . +M)=N.

16) The computer-readable medium of claim 13 wherein the software engine performs optical character recognition (OCR) on plural different languages and each tuned copy of the software engine performs OCR on only a single language.

17) The computer-readable medium of claim 13 wherein the program code further causes the computer system to route processing requests to a tuned copy that has been tuned to generate a solution to a specific type of processing request.

18) The computer-readable medium of claim 13 wherein the tuned copies are modified to process specific subsets of the given input.

19) The computer-readable medium of claim 13 wherein a higher percentage of tuned copies is tuned to process tasks that consume a higher percentage of processing time.

20) A computer system, comprising:
a deployment device having logic to (1) activate multiple copies of a software engine that processes a task to generate a first solution domain and (2) tune the multiple copies so that the tuned multiple copies process the task and generate a second solution domain that is smaller than the first solution domain; and
a production device receiving the tuned multiple copies and having logic to (1) receive a processing task and (2) delegate the processing task to one of the tuned multiple copies that is specifically tuned to process the processing task.

21) The computer system of claim 20 wherein the deployment control logic tunes the multiple copies to perform one of speech analysis, photo analysis, and optical character recognition.

22) The computer system of claim 20 wherein the deployment control logic calculates a number of tuned multiple copies to activate for the production device in order for the production device to optimize processing of received processing tasks.

23) The computer system of claim 20 wherein the tuned multiple copies process the task with a first mean job time (MJT) and the software engine processes the task with a second MJT, the first MJT being smaller than the second MJT.

24) A computer system, comprising:
means for activating multiple copies of an un-tuned software engine that processes a given input to generate a first solution domain;
means for tuning the multiple copes so that the tuned multiple copies process the given input and generate a second solution domain that is smaller than the first solution domain;
means for transmitting the tuned multiple copies to a production device; and
means for delegating, at the production device, processing tasks to one of the tuned multiple copies that is specifically tuned to process the processing tasks.

25) The computer system of claim 24 wherein the means for activating calculates a number of tuned multiple copies to activate for the production device in order for the production device to optimize processing of the processing tasks.
